(19) United States
(12) Patent Application Publication
(10) Pub. No.: US 2005/0289469 A1
(43) Pub. Date: Dec. 29, 2005

(54) Context tagging apparatus, systems, and methods

(76) Inventors: Roger D. Chandler, Portland, OR (US); Uttam K. Sengupta, Portland, OR (US); Shauna L. Pettit-Brown, Portland, OR (US); Nikhil M. Deshpande, Beaverton, OR (US); Johnny Chen, Hillsboro, OR (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/880,157

(22) Filed: Jun. 28, 2004

(51) Int. Cl. G06F 17/00

(52) U.S. Cl. 715/745; 707/104.1

(57) ABSTRACT

An apparatus and a system, as well as a method and article, may operate to store persistent context tag information associated with a geographic location. The persistent context tag information may be subsequently published to a mobile computing device located at a mobile location within a selected distance from the geographic location.

### TECHNICAL FIELD

Various embodiments described herein relate to data processing generally, including the processing of context information in conjunction with various events.

### BACKGROUND INFORMATION

The number and kind of devices capable of capturing information related to various events (e.g., photography in the form of digital images with date and time) continues to grow. At the same time, users may demand a variety of ways to share the information they obtain. Thus, increasingly sophisticated mechanisms may be needed to manage the growing amount of information that is captured, shared, and archived.

### BRIEF DESCRIPTION OF THE DRAWINGS

FIG. 1 is a block diagram of apparatus and systems according to various embodiments of the invention;

FIGS. 2A and 2B are flow diagrams illustrating several methods according to various embodiments of the invention; and

FIG. 3 is a block diagram of an article according to various embodiments of the invention.

### DETAILED DESCRIPTION

Apparatus and systems for marking specific locales with personally created digital media can be used to augment the environment in which electronic devices travel. Multimedia information that is personally interesting may be stored and published to others based on their location in space. Users may thereby be encouraged to actively participate in their environment, expressing themselves via digital media and tying the expression to specific special geographic reference points. Mobile users of wireless communications devices will thus be able to add to the world around them using non-intrusive digital markers, or tags (e.g., video, text, photos, speech, music, etc.) representing their personal thoughts and other information. The tags may be tied into a location-aware server and/or network, allowing other users to experience the tags via their own devices as they approach a particular location in space, perhaps within a specified distance from the tag, and based on preset preferences, filters, and permissions. Indeed, tags may be stored in any memory, including various access points (APs) with access to storage to provide local persistence, if desired. The tags can be public or private; accessible to everyone or restricted to a few.

In some embodiments, mobile devices may be used to capture an event in conjunction with a location and related context information (e.g., date, time, surroundings, impressions, etc.) to create a tag for that particular event. In such a system, a single mobile device may have multiple agents/sensors that capture related context information. When an event is detected by the mobile device (e.g., taking a picture, entering a restaurant, an abrupt change in acceleration, etc.) the mobile device may ask the user if they would like to log the event. If so, the device may capture all related context information and send the recorded information to a logging server in real-time. The logging server may parse the information provided by the device, catalogue it, and add it to the log or archive. Third party authentication services may be used to validate some of the information to verify the occurrence of events.

In some embodiments, a tag associated with an event, a location, and context information (e.g., day, personal information, mood, etc.) may be created using a mobile device. When a certain event occurs, perhaps preselected by the user, the option may be presented with the option to tag it using many available tags. In addition, a user can pre-configure such options to automate tagging. Tags may be applied to anything people create—digital content, pictures, music, speech, comments etc. Electronic tags may also be used as part of services offered at a location, perhaps being offered for free, or bartered and/or sold.

A potential usage scenario may be presented as follows. Joe and Susan have taken a honeymoon trip to Paris. They may bring with them a mobile auto-journaling device (AJD), which can be a device specifically constructed to create a journal in an automated fashion, or perhaps a phone or PDA (personal digital assistant) programmed to operated in a similar manner. In any event, the AJD may be set up to log various events from their trip that will later be compiled and entered into a digital scrapbook. Susan has created a profile within the AJD of the kinds of events and context information to be recorded. The AJD is then prompted to begin the logging process.

For example, the AJD may then communicate with a digital video camera each time the camera is activated. The resulting log may be created using the location of each photograph, information about the site captured by using an scanner, and Susan's voice annotations. In addition, information on each restaurant where they ate, each store where they shopped, and how much money they spent at various places may be recorded to provide a running tally to help monitor spending. Logging may continue until Susan approaches their home computer or a network capable of receiving the information for persistent storage.

Each log entry may be associated with a tag that remains tied to the location associated with the event triggering recordation. The combination of entries may also be associated with each of the tags, and with some amount of editing, compiled into a scrapbook for viewing by Susan's children at some future date, either on-line, or in conjunction with passing through the same locations as their parents. Information sent from the AJD to another computer or network (as well as information broadcast from the server/network to receiving devices) may be formatted according to an Institute of Electrical and Electronics Engineers (IEEE) 802.11, 802.16, or 802.20 standard. The information may also be formatted according to CDMA (Code Division Multiple Access) 2000 and WCDMA (Wideband CDMA) standards.

For more information regarding various IEEE 802.11 standards, please refer to “IEEE Standards for Information Technology—Telecommunications and Information Exchange between Systems—Local and Metropolitan Area Network—Specific Requirements—Part 11: Wireless LAN Medium Access Control (MAC) and Physical Layer (PHY), ISO/IEC 8802-11: 1999” and related amendments. For more information regarding IEEE 802.16 standards, please refer to “IEEE Standard for Local and Metropolitan Area Networks—Part 16: Air Interface for Fixed Broadband Wireless Access Systems, IEEE 802.16-2001”, as well as related amendments and standards, including “Medium Access Control Modifications and Additional Physical Layer Specifications for 2-11 GHz, IEEE 802.16a-2003”. For more information regarding IEEE 802.20 standards, please refer to “IEEE Standard for Local and Metropolitan Area Networks—Part 20: Standard Air Interface for Mobile Broadband Wireless Access Systems Supporting Vehicular Mobility—Physical and Media Access Control Layer Specification, IEEE 802.20 PD-02, 2002”, as well as related amendments and documents, including “Mobile Broadband Wireless Access Systems Access Systems “Five Criteria” Vehicular Mobility, IEEE 802.20 PD-03, 2002.

For more information regarding WCDMA standards, please refer to the various 3rd Generation Partnership Project (3GPP) specifications, including “IMT-2000 DS-CDMA System,” ARIB STD-T63 Ver. 1.4303.100 (Draft), Association of Radio Industries and Businesses (ARIB), 2002. For more information regarding CDMA 2000 standards, please refer to the various 3rd Generation Partnership Project 2 (3GPP2) specifications, including “Physical Layer Standard for CDMA2000 Spread Spectrum Systems,” 3GPP2 C.S0002-D, Ver. 1.0, Rev. D, 2004.

For the purposes of this document, an “electronic device” means any type of mobile computing apparatus having a processor, such as a personal digital assistant (PDA), a laptop computer, and a cellular telephone.

The phrase “persistent context tag information” may include any number of items, such as a time, a date, text, opinion information, rating information, audio information, video information, smell information, tactile information, taste information, proximity information, environmental information (e.g., pollen count, smog index, and weather-related information, such as temperature, humidity, visibility, wind speed, etc.)and previous context tag information. However, the persistent context tag information does not include geographic location data.

The term “publish” includes broadcasting any type of information from one device to another such that the broadcast information may be conveyed to an electronic device at some time after the broadcast begins, via storage and subsequent display, radio transmission and demodulation, etc.

The term “transceiver” (e.g., a device including a transmitter and a receiver) may be used in place of either “transmitter” or “receiver” throughout this document. Thus, anywhere the term transceiver is used, “transmitter” and/or “receiver” may be substituted.

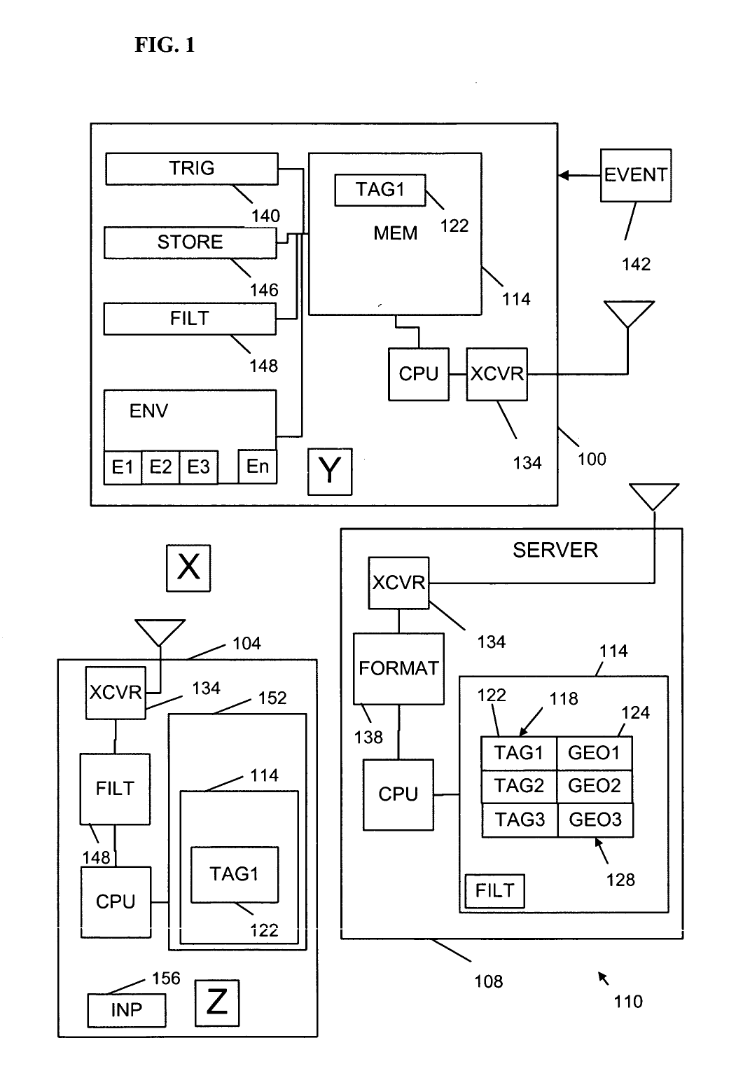

FIG. 1 is a block diagram of apparatus 100, 104, 108 and systems 110 according to various embodiments of the invention, each of which may operate in the manner described above. For example, an apparatus 100, 108 may comprise a memory 114 to store persistent context tag information 118 associated with a geographic location X (e.g., a particular instance of context tag information 122 may be stored in conjunction with one or more specific indications 124, perhaps comprising a particular instance of geographic information GEO1, such as coordinates, associated with the geographic location X). The apparatus 100, which may comprise a mobile computing apparatus, such as a personal digital assistant (PDA) or a cellular telephone, may initiate recordation of the persistent context tag information 118 upon encountering an event and/or location X, or location Y, at some selected distance from X. The distance between X and Y may be selected or determined via radio frequency range, signal strength, GPS (Global Positioning System) coordinates, and in any number of other ways. The persistent context tag information 118 may be immediately published to another apparatus 104, such as a mobile computing device, located at a mobile location Z within a selected distance from the geographic location X. In some embodiments, indications of geographic information 128 stored in conjunction with the persistent context tag information 118 may define geographic locations, such as geographic location X, for example, and/or some range of coordinates within a selected distance of selected geographic locations, such as geographic location X.

The persistent context tag information 118 may be also be subsequently published to the apparatus 104. For example, the persistent context tag information 118 may be stored on another apparatus 108, comprising a server, for example, when the apparatus 104 moves to location Z. The apparatus 108 may comprise a transceiver 134, perhaps including a transmitter, to transmit the persistent context tag information 118 associated with a geographic location X. The persistent context tag information 118 may thus be stored and subsequently published to the apparatus 104, such as a mobile computing device, located at a mobile location Z within a selected distance from the geographic location X. In some embodiments, the apparatus 108 may include a formatting module 138 coupled to the transceiver 134 to format the persistent context tag information 118 according to an IEEE 802.11, 802.16, or 802.20 standard, as well as a WCDMA or CDMA2000 standard. In some embodiments, the apparatus 108 may include a memory 114 to store the persistent context tag information 118, as well as one or more indications 128, perhaps comprising geographic information GEO1, associated with the geographic location X.

In some embodiments, the apparatus 100 may include a trigger module 140 to detect an event 142 associated with the persistent context tag information 118. For example, the event 142 may be selected from any number of happenings, including encountering geographic location X, or geographic location Y (at some selected distance from geographic location X). Other events 142 may include, but are not limited to, taking a picture, entering a voice note, entering a commercial establishment, encountering an electronic device, executing a commercial transaction, etc. The apparatus 100 may also include a module 146 to automatically store the persistent context tag information 118 according to a recording policy, perhaps based on the occurrence of an event 142.

In some embodiments, the apparatus 104 may also comprise a transceiver 134, perhaps including a wireless receiver module to receive the persistent context tag information 118. The apparatus 104 may also include a module 148 to select a subset of the persistent context tag information 122 according to a filtering policy. Filters may be implemented via buddy lists, profile definitions, and/or the communication of the capabilities devices, such as the apparatus 104, operating at geographic location Z within some specified distance (or a receiving range determined by environmental conditions) of the geographic location X. Other embodiments may be realized.

For example, a system 110 may comprise a module 152, perhaps including a memory 114, similar to or identical to that described previously, to store persistent context tag information 118 associated with a geographic location X. The system 110 may also include an input device 156 to access some portion of the persistent context tag information 122. The input device 156 may be selected from one of a keyboard, a microphone, a pointing device, a touch screen, a joystick, and a display, among others.

In some embodiments, the system 110 may include an apparatus 108, perhaps comprising a wireless access point, to transmit the persistent context tag information 118. The system 110 may also include a module to receive environmental information E1, E2, E3, . . . , En from a plurality of proximate devices, such as the apparatus 100. The environmental information E1, E2, E3, . . . , En may comprise a number of elements, including a temperature, a time, a date, a humidity, a weather condition, a mood, a lighting level, a photograph or movie clip, and an identification of other apparatus 104, 108, among others. A subset of the environmental information E1, E2, E3, . . . , En may be included as a part of the persistent context tag information 118.

The apparatus 100, 104, 108, systems 110, memories 114, persistent context tag information 118, 122, indications 124, 128, transceiver 134, formatting module 138, trigger module 140, event 142, module 146, module 148, module 152, input device 156, environmental information E1, E2, E3, . . . , En, geographic information GEO1, GEO2, GEO3, and geographic locations X, Y, Z, may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100, 104, 108 and systems 110, and as appropriate for particular implementations of various embodiments.

It should also be understood that the apparatus and systems of various embodiments can be used in applications other than wireless access points, and thus, various embodiments are not to be so limited. The illustrations of an apparatus 100, 104, 108 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, PDAs, workstations, radios, video players, vehicles, and others.

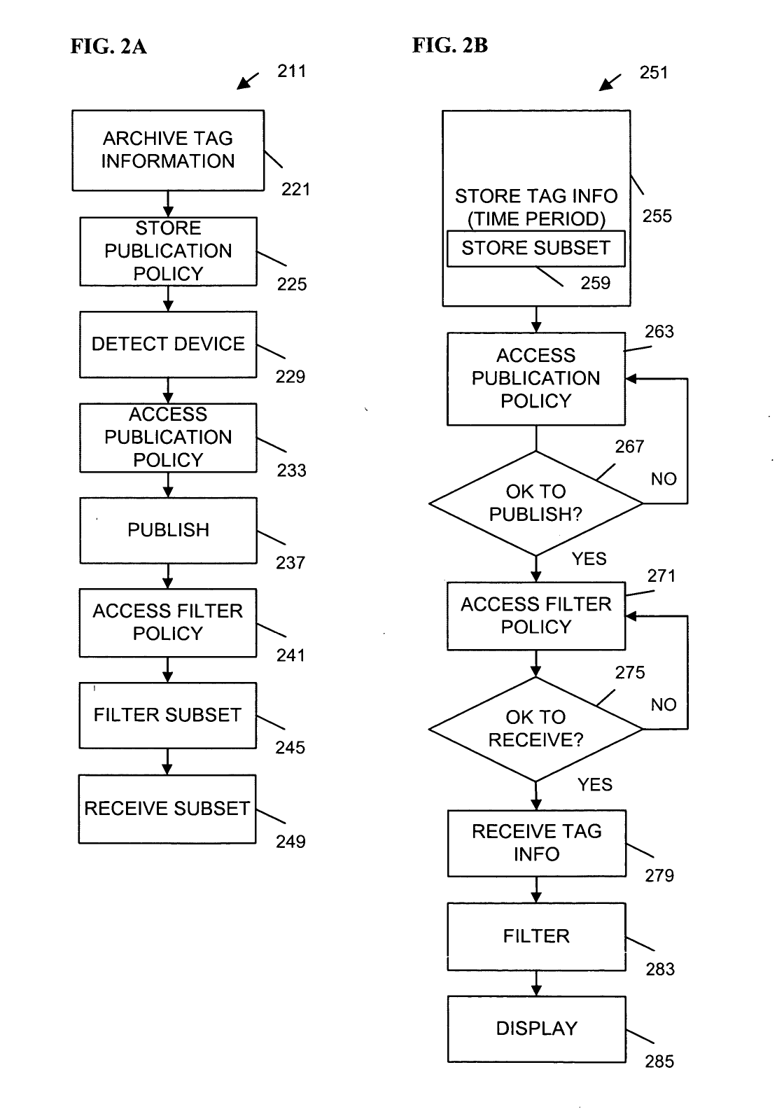

FIGS. 2A and 2B are flow diagrams illustrating several methods according to various embodiments of the invention. In some embodiments, a method 211 may (optionally) begin with storing persistent context tag information associated with a geographic location at block 221. The persistent context tag information may be subsequently published to a mobile computing device located at a mobile location within a selected distance from the geographic location, as noted previously. This activity may be augmented by archiving the persistent context tag information on a server having accumulated context tag information associated with a plurality of geographic locations including the geographic location.

In some embodiments, the method 211 may include storing a publication policy to separate a first group of context tag information and a second group of context tag information at block 225. The first group of context tag information and the second group of context tag information may be included in the persistent context tag information, for example, and the first group of context tag information may be associated with public information, and the second group of context tag information may be associated with private information. Thus, the first group of context tag information may be available to everyone, and the second group of context tag information may only be available to a selected few.

In some embodiments, the method 211 may include detecting a mobile computing device at a mobile location within a selected distance from a geographic location at block 229. The method 211 may include accessing a publication policy associated with the persistent context tag information at block 233, and, if permitted by the publication policy, publishing at least a subset of the persistent context tag information to the mobile computing device at block 237. For example, a publication policy may be based on the specific identity of a receiving party, membership in a group (e.g., a buddy list), the time of day, the country in which the tag is located, and any number or combination of other criteria defined by the creator of the policy (which may be a user of the device creating a tag). Throughout this document, it should be understood that publication may include transmitting the persistent context tag information as a data stream including information formatted according to an IEEE 802.11, 802.16, or 802.20 standard, as well as a WCDMA or CDMA2000 standard.

In some embodiments, the method 211 may include accessing a filtering policy associated with the mobile computing device at block 241, filtering the persistent context tag information to provide a subset of the persistent context tag information at block 245, and, if permitted by the filtering policy, receiving at least a subset of the persistent context tag information at the mobile computing device at block 249. In a manner similar to that described for a publication policy, filters may be aggregated to form a filtering policy, or reception policy. For example, a filtering policy may be based on the specific identity of a party leaving a tag, the fact that a tag has a characteristic that makes it part of a selected group (e.g., a list of merchants in a mall), the time of day, the identity of the user logged in to the receiving device, and any number or combination of other criteria defined by the creator of the policy, which in some cases may be the user of the receiving device. Many other embodiments may be realized.

For example, a method 251 may include storing persistent context tag information associated with a geographic location, wherein the persistent context tag information is to be subsequently published to a mobile computing device located at a mobile location within a selected distance from the geographic location at block 255. In some embodiments, the method 251 may include storing at least a subset of the persistent context tag information in the mobile computing device and/or a server (at block 259). In either case, the method 251 may include storing the persistent context tag information for a determined time period.

In some embodiments, the method 251 may include accessing a policy at block 263 (e.g., prior to publishing the persistent context tag information). If permitted by the publication policy at block 267, the method 251 may continue on to block 271. If publication is not permitted, the method 251 may continue on to block 263.

The method 251 may continue on to accessing a filtering policy associated with the mobile computing device (and/or the persistent context tag information, and/or the geographic location, in some embodiments) at block 271, and, if permitted by the filtering policy at block 275, receiving at least a subset of the persistent context tag information at the mobile computing device at block 279.

In some embodiments, the method 251 may include further filtering of the persistent context tag information to provide a more limited subset of the persistent context tag information at block 283. The method 251 may also include displaying at least a portion of the more limited subset of the persistent context tag information at a mobile computing device at block 285.

It should be noted that the methods described herein do not have to be executed in the order described, or in any particular order. Moreover, various activities described with respect to the methods identified herein can be combined and/or executed in simultaneous, serial, or parallel fashion. For the purposes of this document, the terms “information” and “data” may be used interchangeably. Information, including parameters, commands, operands, and other data, can be sent and received in the form of one or more carrier waves.

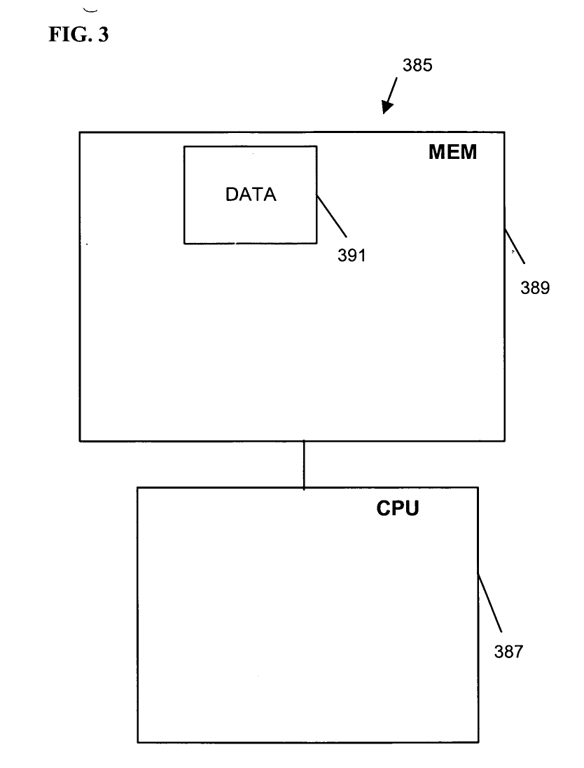

Upon reading the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including remote procedure calls. The teachings of various embodiments are not limited to any particular programming language or environment. Thus, other embodiments may be realized, as shown in FIG. 3.

FIG. 3 is a block diagram of an article 385 according to various embodiments of the invention, such as a computer, a memory system, a magnetic or optical disk, some other storage device, and/or any type of electronic device or system. The article 385 may comprise a processor 387 coupled to a machine-accessible medium such as a memory 389 (e.g., a memory including an electrical, optical, or electromagnetic conductor) having associated information 391 (e.g., computer program instructions, and/or other data), which when accessed, results in a machine (e.g., the processor 387) performing such actions as storing persistent context tag information associated with a geographic location, wherein the persistent context tag information is to be subsequently published to a mobile computing device located at a mobile location within a selected distance from the geographic location. Other activities may include archiving the persistent context tag information on a server having accumulated context tag information associated with a plurality of geographic locations including the geographic location.

Further activities may include storing a publication policy to separate a first group of context tag information and a second group of context tag information. As noted previously, the first group of context tag information and the second group of context tag information may be included in the persistent context tag information, and the first group of context tag information may be associated with public information, while the second group of context tag information may be associated with private information. Such activities may include accessing the policy prior to publishing the persistent context tag information. In some embodiments, the activities may include filtering the persistent context tag information to provide a subset of the persistent context tag information, as well as displaying the subset of the persistent context tag information at a mobile computing device.

Implementing the apparatus, systems, and methods described herein may result in providing an automated mechanism for journal event coverage. Other benefits may include the creation and storage of persistent tag information, as selected manually, or in response to the occurrence of preselected events. The existence of such tags may provide a more efficient mechanism for managing the increasing volume of data created by the various types of event capture apparatus used by various groups of consumers.

Although the inventive concept may be discussed in the exemplary context of an IEEE 802.xx implementation (e.g., IEEE 802.11a, IEEE 802.11g, IEEE 802.11 HT, etc.), the claims are not so limited. Indeed, embodiments of the present invention may well be implemented as part of any wireless system, including those conforming to various versions of the IEEE 802.16 and 802.20 standards, as well as WCDMA and CDMA2000 standards, and/or using multi-carrier wireless communication channels (e.g., orthogonal frequency-division multiplexing (OFDM), discrete multi-tone modulation (DMT), etc.), such as may be used within, without limitation, a wireless personal area network (WPAN), a wireless local area network (WLAN), a wireless metropolitan are network (WMAN), a wireless wide area network (WWAN), a cellular network, a third generation (3G) network, a fourth generation (4G) network, a universal mobile telephone system (UMTS ), and similar communication systems.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A method, including:
storing persistent context tag information associated with a geographic location, wherein the persistent context tag information is to be subsequently published to a mobile computing device located at a mobile location within a selected distance from the geographic location.

2. The method of claim 1, further including:
storing at least a subset of the persistent context tag information in at least one of the mobile computing device and a server.

3. The method of claim 1, further including:
accessing a publication policy associated with the persistent context tag information; and
if permitted by the publication policy, publishing at least a subset of the persistent context tag information to the mobile computing device.

4. The method of claim 1, further including:
accessing a filtering policy associated with the mobile computing device; and
if permitted by the filtering policy, receiving at least a subset of the persistent context tag information at the mobile computing device.

5. The method of claim 1, further including:
storing the persistent context tag information for a determined time period.

6. The method of claim 1, further including:
transmitting the persistent context tag information as a data stream formatted according to one of an Institute of Electrical and Electronics Engineers (IEEE) 802.11 standard, an IEEE 802.16 standard, an IEEE 802.20 standard, a Code Division Multiple Access (CDMA) 2000 standard, and a Wideband CDMA standard.

7. The method of claim 1, wherein the persistent context tag information includes at least two of a time, a date, text, opinion information, rating information, audio information, video information, smell information, tactile information, taste information, proximity information, environmental information, and previous context tag information.

8. An article including a machine-accessible medium having associated information, wherein the information, when accessed, results in a machine performing:
storing persistent context tag information associated with a geographic location, wherein the persistent context tag information is to be subsequently published to a mobile computing device located at a mobile location within a selected distance from the geographic location.

9. The article of claim 8, wherein the information, when accessed, results in the machine performing:
archiving the persistent context tag information on a server having accumulated context tag information associated with a plurality of geographic locations including the geographic location.

10. The article of claim 8, wherein the information, when accessed, results in the machine performing:
accessing a policy prior to publishing the persistent context tag information.

11. The article of claim 8, wherein the information, when accessed, results in the machine performing:
storing a publication policy to separate a first group of context tag information and a second group of context tag information, wherein the first group of context tag information and the second group of context tag information are included in the persistent context tag information.

12. The article of claim 11, wherein the first group of context tag information is associated with public information, and wherein the second group of context tag information is associated with private information.

13. The article of claim 12, wherein the information, when accessed, results in the machine performing:
filtering the persistent context tag information to provide a subset of the persistent context tag information; and
displaying the subset of the persistent context tag information at a mobile computing device.

14. An apparatus, including:
a memory to store persistent context tag information associated with a geographic location, wherein the persistent context tag information is to be subsequently published to a mobile computing device located at a mobile location within a selected distance from the geographic location.

15. The apparatus of claim 14, further including:
a wireless receiver module to receive the persistent context tag information.

16. The apparatus of claim 14, further including:
an trigger module to detect an event associated with the persistent context tag information.

17. The apparatus of claim 14, further including:
a module to select a subset of the persistent context tag information according to a filtering policy.

18. The apparatus of claim 14, further including:
a module to automatically store the persistent context tag information according to a recording policy.

19. An apparatus, including:
a transmitter to transmit persistent context tag information associated with a geographic location, wherein the persistent context tag information is to be stored and subsequently published to a mobile computing device located at a mobile location within a selected distance from the geographic location.

20. The apparatus of claim 19, further including:
a formatting module coupled to the transmitter to format the persistent context tag information according to one of an Institute of Electrical and Electronics Engineers (IEEE) 802.11 standard, an IEEE 802.16 standard, an IEEE 802.20 standard, a Code Division Multiple Access (CDMA) 2000 standard, and a Wideband CDMA standard.

21. The apparatus of claim 19, further including:
a memory to store the persistent context tag information and an indication associated with the geographic location.

22. A system, including:
a module to store persistent context tag information associated with a geographic location, wherein the persistent context tag information is to be subsequently published to a mobile computing device located at a mobile location within a selected distance from the geographic location; and
an input device to access the persistent context tag information.

23. The system of claim 22, wherein the input device is selected from one of a keyboard, a microphone, a pointing device, a touch screen, a joystick, and a display.

24. The system of claim 22, further including:
a wireless access point to transmit the persistent context tag information.

25. The system of claim 22, further including:
a module to receive environmental information from a plurality of proximate devices and to include at least a subset of the environmental information as a part of the persistent context tag information.

26. A method, including:
detecting a mobile computing device at a mobile location within a selected distance from a geographic location; and
receiving at least a subset of persistent context tag information associated with the geographic location at the mobile computing device.

27. The method of claim 26, further including:
accessing a filtering policy associated with the mobile computing device and the persistent context tag information.

28. The method of claim 26, further including:
filtering the persistent context tag information to provide the subset of the persistent context tag information; and
displaying at least a portion of the subset of the persistent context tag information at the mobile computing device.
